(19) United States
(12) Patent Application Publication
(10) Pub. No.: US 2010/0082180 A1
(43) Pub. Date: Apr. 1, 2010

(54) ERRANT VEHICLE COUNTERMEASURES

(75) Inventors: George L. Wright, Corrales, NM (US); Mark A. Wright, Albuquerque, NM (US)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/243,615

(22) Filed: Oct. 1, 2008

(51) Int. Cl. G06F 7/00; G06F 17/00; G09F 9/37; G06F 7/04

(52) U.S. Cl. 701/1; 701/300; 340/5.7; 40/446; 340/5.2

(57) ABSTRACT

A method, system, and device are presented for providing countermeasures against errant vehicles. A countermeasure controller determines a vehicle-velocity vector based on data from one or more sensors and compares the vehicle-velocity vector to an authorized-velocity vector. The vehicle is determined to be an errant vehicle if the vehicle-velocity vector is not aligned with the authorized-velocity vector. Then, the countermeasure controller may apply countermeasures to the errant vehicle. The countermeasures include electronic countermeasures, informational countermeasures, and physical countermeasures. The countermeasure controller can provide information to other drivers about the errant vehicle via personalized communication or electronic warning signs. The countermeasure controller can be configured to detect entry of vehicles into security areas based on data from one or more sensors. The countermeasure controller may then apply countermeasures to vehicles attempting unauthorized entry into a security area.

### BACKGROUND OF THE INVENTION

1. Field of the Invention

This invention relates to the field of controlling errant vehicles. More particularly, this invention relates to applying countermeasures to slow and/or stop errant vehicles.

2. Background

Most motor-vehicle operators travel safely in authorized directions, such as in the direction of the prevailing flow of traffic on a road. However, on occasions such as when a motor-vehicle operator is tired, lost, or intoxicated, the motor vehicle may travel in an “errant direction”. Example errant directions are against the prevailing flow of traffic and in the opposite direction to entries/exits of controlled-access highways (e.g., the driver attempts to enter the controlled-access highway via an off-ramp). A motor vehicle traveling in an errant direction is termed herein as an “errant vehicle”.

Errant vehicles pose an obvious hazard to other vehicles on the roads, as they travel in directions unexpected by other motor-vehicle operators and thus may collide with motor vehicles traveling in authorized directions. In particular, an errant vehicle is likely to be in a head-on collision if traveling in the opposite direction to the prevailing flow of traffic, which further increases the risk of injury and fatalities. Further, errant vehicles are a hazard to the operator of the errant vehicle, as well as to pedestrians and to roadside property.

### SUMMARY

A first embodiment of the invention provides a method. An authorized-velocity vector is determined. Sensor data is received from one or more sensors. A vehicle-velocity vector of a vehicle is determined, based on the sensor data. The vehicle-velocity vector comprises a magnitude component and a direction component. A difference between the vehicle-velocity vector and the authorized-velocity vector is determined. The difference is based on the magnitude component and the direction component of the vehicle-velocity vector. The difference is compared to a threshold. Responsive to determining that the vehicle-velocity vector exceeds the threshold, a countermeasure is applied to the vehicle.

A second embodiment of the invention provides a countermeasure controller. The countermeasure controller includes a processor, data storage, a sensor interface, and machine language instructions. The machine language instructions are stored in the data storage and executable by the processor to perform functions. The functions include determining that an entering vehicle is attempting to enter a security area based on sensor data received via the sensor interface, requesting authorization data for the entering vehicle, receiving the requested authorization data, determining that a vehicle is authorized based on the authorization data, and responsive to determining that the vehicle is not authorized, applying a countermeasure to the vehicle.

A third embodiment of the invention provides a vehicle-countermeasure device. The vehicle-countermeasure device includes a processor, data storage, a network interface, and machine language instructions. The machine language instructions are stored in the data storage and executable by the processor to perform functions. The vehicle-countermeasure device is configured to receive the vehicle-countermeasure command via the network interface, determine that the vehicle-countermeasure command is valid, and responsive to determining that the vehicle countermeasure command is valid, apply a countermeasure to the vehicle based on the vehicle-countermeasure command.

### BRIEF DESCRIPTION OF THE DRAWINGS

Various examples of embodiments are described herein with reference to the following drawings, wherein like numerals denote like entities, in which:

FIG. 1 shows an example scenario in which a countermeasure controller could apply countermeasures to an errant vehicle, in accordance with embodiments of the invention;

FIG. 1A shows an example scenario in which a countermeasure controller could apply countermeasures as directed by a traffic manager, in accordance with embodiments of the invention;

FIG. 2 shows an example scenario in which an electronic countermeasure device could apply countermeasures to an errant vehicle, in accordance with embodiments of the invention;

FIG. 3 shows an example scenario in which countermeasures could be applied to vehicles entering one or more security areas, in accordance with embodiments of the invention;

FIG. 4 is a block diagram of an example computing device, in accordance with embodiments of the invention;

FIG. 5 is a flowchart depicting an example method for applying countermeasures to a vehicle, in accordance with an embodiment of the invention;

FIG. 6 is a flowchart depicting an example method for applying electronic countermeasures to a vehicle, in accordance with an embodiment of the invention; and

FIG. 7 is a flowchart depicting an example method for determining authorized entry into a secured area, in accordance with an embodiment of the invention.

### DETAILED DESCRIPTION

The present invention includes a countermeasure controller configured to apply countermeasures to errant vehicles. The countermeasure controller may determine that a vehicle is an errant vehicle based on sensor data that provides location and/or velocity information about the vehicle. Using the sensor data, a vehicle-velocity vector may be calculated. The vehicle-velocity vector may be compared to an authorized-velocity vector that represents the prevailing flow of traffic along a roadway. In particular, a difference between the authorized-velocity vector and the vehicle-velocity vector may be calculated and the difference compared to a threshold. If the difference exceeds the threshold, then the countermeasure controller may then determine the vehicle is not traveling with the prevailing flow of traffic, and thus is an errant vehicle.

After determining that the vehicle is an errant vehicle, countermeasures may be applied to the vehicle, including physical countermeasures, informational countermeasures, and/or electronic countermeasures. Physical countermeasures may include barriers, walls, and other physical devices that act to change the velocity (direction and/or speed) of the errant vehicle.

The informational countermeasures may include sirens, lights, signs and/or other indications that the vehicle is traveling against the prevailing flow of traffic. The informational countermeasures may include warnings to other drivers, such as providing errant vehicle warnings on electronic warning signs alongside roadways, electronic messages to drivers, and/or updating websites, including blogs, with information about errant vehicles. The informational countermeasures may include indications provided to the driver of the errant vehicle, such as a request to slow down, stop, or change directions.

Electronic countermeasures may include vehicle-countermeasure commands. A vehicle-countermeasure command may instruct the errant vehicle to stop, slow, change a vehicle-control parameter, such as the fuel-flow of the vehicle, and/or change the direction of the errant vehicle. The countermeasure controller may send vehicle-countermeasure commands to a vehicle-countermeasure device within the errant vehicle. The vehicle-countermeasure device may apply the electronic countermeasures after validating the vehicle-countermeasure command. The vehicle-countermeasure command may be validated based on a vehicle-countermeasure code sent with the vehicle-countermeasure command. The vehicle-countermeasure command may be encrypted or otherwise secured to prevent third-party interception and/or sending of vehicle-countermeasure commands.

In another arrangement, the countermeasure controller may monitor a security area or areas to ensure authorized vehicles only enter the security area(s). The countermeasure controller may receive sensor data that that provides location and/or velocity information about a vehicle entering into a security area. The countermeasure controller may compare the sensor data to the boundary of the security area to determine that the entering vehicle is attempting to enter the security area. The security area may have designated entry and/or exit points where entering vehicles—vehicles attempting to enter the security area at other points may be considered as unauthorized vehicles.

The countermeasure controller may send an authorization-data request for authorization data to the entering vehicle. A device in the entering vehicle, such as a security device, may receive the authorization-data request and responsively send the authorization data in an authorization-data response. Both the authorization-data request and the authorization-data response may be secured (i.e., encrypted or otherwise encoded). The authorization-data request for a specific security area may be transmitted on a specific frequency and the security device may correspondingly transmit the authorization-data response on the specific frequency.

The countermeasure controller may then determine the authorization data is valid (or invalid) based on a query sent to an authorization database. The query may include the received authorization data. If the authorization data is found to be invalid or the authorization-data response is not received within a specified time, the countermeasure controller may determine that the entering vehicle is an unauthorized vehicle. If the authorization data is found to be valid, then the countermeasure controller may determine that the entering vehicle is an authorized vehicle.

The countermeasure controller may permit authorized vehicles to enter the security area. On the other hand, the countermeasure controller may apply countermeasures, including physical, electronic, and/or informational countermeasures, to unauthorized vehicles.

Example Errant Vehicle Scenarios

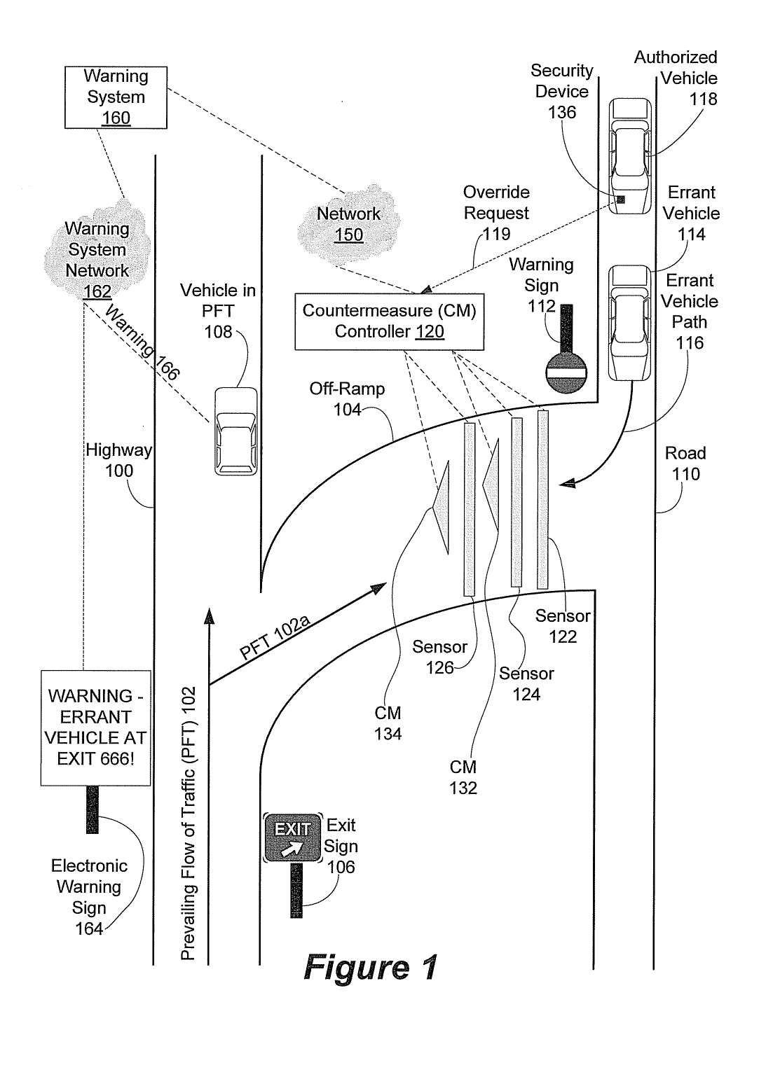

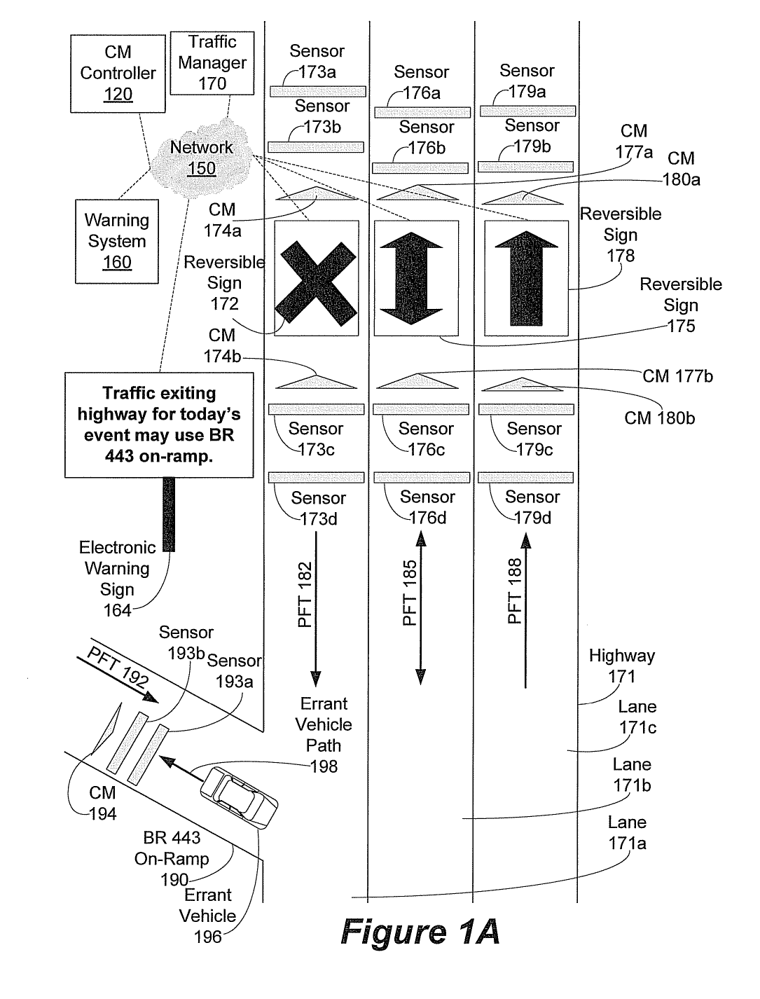

Turning to the figures, FIG. 1 shows an example errant vehicle scenario in which a countermeasure (CM) controller 120 could apply countermeasures 132 and 134 to an errant vehicle 114, in accordance with embodiments of the invention.

The scenario shown in FIG. 1 is of a highway 100 with traffic flowing along prevailing flows of traffic (PFT) 102 and 102a, connected to road 110 via an off-ramp 104. The off-ramp 104 is marked by an exit sign 106. Vehicles on the road 110 are warned from entering off-ramp 104 by use of a warning sign 112.

If a vehicle attempts to enter highway 100 from road 110 via off-ramp 104, the vehicle would travel against the PFT 102a, and thus be considered an errant vehicle. FIG. 1 shows an errant vehicle 114 attempting to travel along errant vehicle path 116 onto off-ramp 104.

FIG. 1 shows the countermeasure controller 120 connected to sensors 122, 124, and 126 as well as countermeasures 132 and 134. To aid understanding, the sensors 122-126 are depicted as rectangles in FIG. 1 and countermeasures 132-134 are depicted as triangles in the off-ramp 104. However, the sensors 122-126 and/or countermeasures 132-134 may or may not be of the shapes shown in FIG. 1.

The countermeasure controller 120 and the sensors 122-126 and countermeasures 132-134 may be directly connected using wired and/or wireless communication techniques. The countermeasure controller 120 and the sensors 122-126 and/or countermeasures 132-134 may be indirectly connected, such as via a network. For example, in an embodiment not shown in FIG. 1, the sensors 122-126 and/or the countermeasures 132-134 may be connected to the countermeasure controller 120 via the data network 150.

FIG. 1 shows the sensors 122-126 and the countermeasures 132-134 embedded in the off-ramp 104. The sensors 122-126 and/or countermeasures 132-134 may be in, under, over, near, and/or alongside a road, highway, driveway, parkway, street, boulevard, lane, parking lot, access road, ramp, waterway, or other surface over which vehicles travel where countermeasures could be applied.

As the errant vehicle 114 travels along errant vehicle path 116, a velocity of the errant vehicle may be determined by use of sensors 122-126. While FIG. 1 shows sensors 122-126 on off-ramp 104, sensors 122-126 may be embedded in or placed near the road 110 and/or the highway 100 as well. Each of sensors 122-126 is configured to detect a position or velocity of the errant vehicle 114. The sensors may then be magnetic sensors, infrared sensors, video sensors, sound detectors, motion detectors, electronic sensors, radar devices, laser-based sensors such as Light Detection and Ranging (LIDAR) devices, optical, and/or electro-mechanical tripwires, and/or pressure sensors. Other sensors operable to detect a position and/or a velocity of the errant vehicle 114 are possible as well.

Each sensor 122-126 may then send sensor data to the countermeasure controller 120. For example, if sensor 122 is a magnetic sensor, the sensor 122 may send a sensor indication that the sensor is near an object made up of ferrous material. Along with sensor data, such as a sensor reading, the sensor 122-126 may send a sensor identifier, location information (e.g., 10 yards from road 100 on on-ramp 104), and/or sensor data time information as part of a sensor indication. As another example, if sensor 122 is a video sensor, the sensor 122 may send video information to the countermeasure controller 120. In this case, the countermeasure controller 120 may be equipped with image processing software that determines if features, such as vehicles, are present in the image and then determines any movement of the features over time.

The countermeasure controller 120 may then receive indications from the sensors 122-126 and determine a vehicle-velocity vector for the errant vehicle 114. The vehicle-velocity vector may be expressed with direction and magnitude components. The direction component may include direction(s) expressed in one or more dimensions, such as a north-south dimension and/or an east-west dimension, latitude and/or longitude dimensions, X and/or Y coordinates, (specialized) grid coordinates, and/or directions specified in terms of street and/or roadway names, among others. The magnitude may express a speed of the vehicle, expressed in dimensions such as miles/hour, kilometers/hour, or using other suitable units.

The countermeasure controller 120 may compare the determined vehicle-velocity vector with an authorized-velocity vector. The authorized-velocity vector may be associated with a roadway and expressed using direction and magnitude components. Example authorized-velocity vectors are the PFT 102 for the highway 100 and the PFT 102a for the off-ramp 104. A plurality of authorized-velocity vectors for a road network may be stored in a database, such as a relational database or similar data structure. The database may be indexed by location, such as a location specified by location information provided as part of a sensor indication. As such, a query to the database may include location information and the database may respond to the query with the authorized-velocity vector for the location represented by the location information. The magnitude information of the authorized-velocity vector may indicate a speed limit of the associated roadway.

Once the countermeasure controller 120 determines both the vehicle-velocity vector and the authorized-velocity vector, the countermeasure controller 120 may determine if a vehicle traveling in the direction and/or at the speed represented by the vehicle-velocity vector is an errant vehicle. The countermeasure controller 120 may compare the direction of the vehicle-velocity vector to the direction of the authorized-velocity vector. The directions of the vectors may be compared on a coordinate-by-coordinate basis, by vector subtraction to determine a vector difference, by use of a dot product to determine a vector difference angle, or by other similar techniques that can be used to compare vectors.

For example, the countermeasure controller 120 may compare each coordinate of the vehicle-velocity vector to the corresponding coordinate of the authorized-velocity vector, and if the difference between the two coordinates exceeds a vector-coordinate threshold, the vehicle may be determined to be an errant vehicle. As another example, the countermeasure controller 120 may subtract the authorized vehicle vector from the vehicle-velocity vector (or vice versa) to determine the vector difference. Then, the vehicle may be determined to be an errant vehicle if the vector difference exceeds a vector-difference threshold. As a third example, a dot product may be taken between the authorized-velocity vector and the vehicle-velocity vector. The resulting dot-product result may be interpreted, after scaling by a magnitude product (i.e., the product of the magnitudes of the authorized-velocity vector and the vehicle-velocity vector), as the cosine of a vector-difference angle. Then by taking the arc-cosine of the dot-product divided by the magnitude product, a vector-difference angle may be determined. Subsequently, if the vector-difference angle is greater than a vector-difference-angle threshold, the vehicle may be determined to be an errant vehicle. Each of the aforementioned thresholds may be determined by user input, by use of a formula or other algorithm, by analysis of historical data (e.g., traffic patterns on the associated roadway), and/or by other techniques that lead to the appropriate threshold value(s).

Once a vehicle is determined to be an errant vehicle, such as the errant vehicle 114 depicted in FIG. 1, the countermeasure controller 120 may apply countermeasures to slow, stop, and/or change the direction of the errant vehicle 114. FIG. 1 shows countermeasures 132 and 134 connected to the countermeasure controller 120. The countermeasures 132 and 134 may be physical countermeasures, informational countermeasures, electronic and/or electromagnetic countermeasures, and/or other countermeasures configured to slow, stop and/or change the direction of an errant vehicle, including but not limited to incendiary devices like flamethrowers.

Physical countermeasures may include barriers or walls, tire-puncture devices (e.g., “alligator teeth”), gates, drawbridges, oils, foams, or other mechanical, electro-mechanical, or other physical devices that act to slow, stop, and/or change the direction of the errant vehicle 114. The physical countermeasures may be activated based on signals from the countermeasure controller 120. For example, the countermeasure controller 120 may send a signal to a motor or similar device to move one or more barriers, tire-puncture devices, gates, drawbridges, oils, foams, or other physical countermeasure into the errant vehicle path 116 upon detection that a vehicle is an errant vehicle 114.

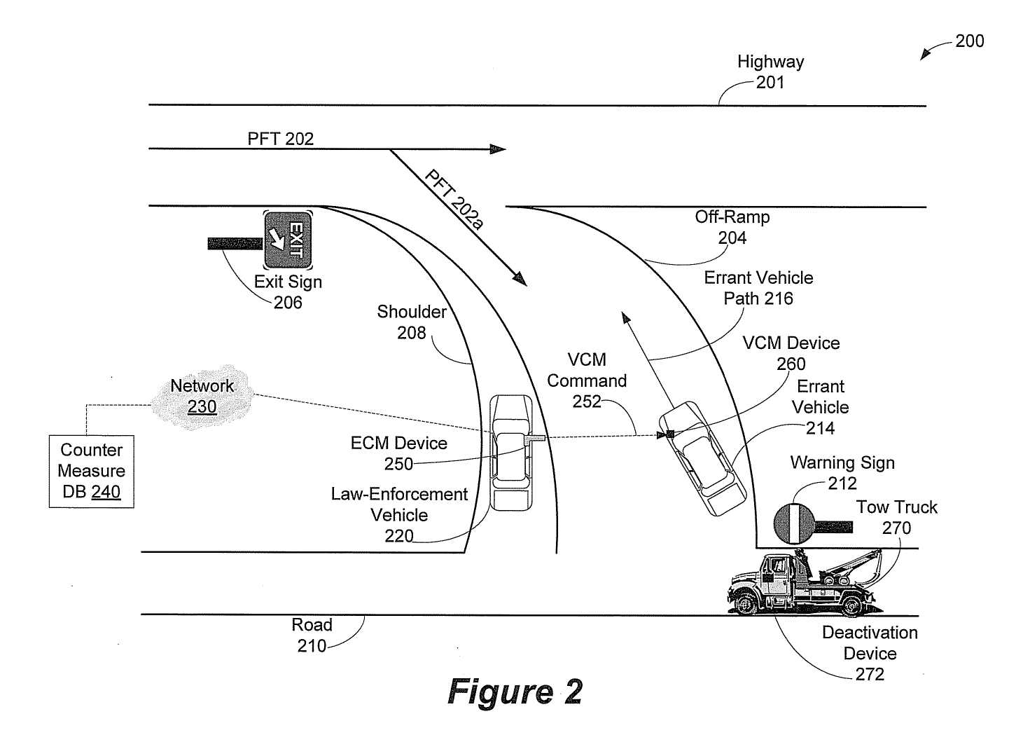

Informational countermeasures include sound emitters (e.g., sirens, horns), lights, signs, and/or other devices that provide information that may lead a driver to slow, stop and/or change the direction of the errant vehicle 114. Electromagnetic countermeasures may send signals designed to partially or completely disable electronic devices within the vehicle, such as sending an electromagnetic pulse aimed at the errant vehicle 114. Electronic countermeasures may send control signals that slow, stop, and/or change the direction of the errant vehicle 114, which are described below in more detail with reference to FIGS. 2, 3, and 6.

The countermeasures may be applied as part of an escalation strategy. The escalation strategy may include applying countermeasures in a sequential order, perhaps as sensors provide sensor information to the countermeasure controller 120. For example, suppose that the countermeasure controller 120 determines that the errant vehicle 114 has passed sensors 122 and 124 when the sensors 122 and 124 each respectively provided sensor data to the countermeasure controller 120. After passing sensor 124, the countermeasure controller 120 may apply countermeasure 132. Then, after receiving information from sensor 126 about the errant vehicle 114, the countermeasure controller 120 may then apply countermeasure 134.

The countermeasure 134 may be an escalation of countermeasure 132 applied as part of an escalation strategy; for example, countermeasure 132 may be an informational countermeasure, such as flashing lights or a siren, and countermeasure 134 may be a physical countermeasure, such as a gate or light barrier. The escalation strategy may be controlled by the physical connections of the countermeasures 132-134 to the countermeasure controller 120 (e.g., a countermeasure connected to a first specific port or physical location on the countermeasure controller 120 will always be applied first, then a countermeasure connected to a second specific port or physical location on the countermeasure controller 120 will always be applied second, etc.). The escalation strategy may instead, or in addition, be controlled by hard-coded and/or user-programmable software. For example, the software within the countermeasure controller 120 may enforce a hard-coded escalation strategy (e.g., informational countermeasures are always applied before physical countermeasures), or the software may permit a user, such as an administrator, of the countermeasure controller 120 to set up escalation strategies on a per roadway basis, a per road network basis, a geographical basis, on a time-varying basis (e.g., that change at a specific time or times during the day), and/or based on other user-selected criteria.

The countermeasure controller 120 may be connected to a data network 150. The countermeasure controller 120 may be able to send and/or receive information via the data network 150. For example, the countermeasure controller 120 may determine authorized vehicle vectors by sending database queries via the data network 150 to a database located remotely from the countermeasure controller 120.

The countermeasure controller 120 may communicate, perhaps via network 150, to a warning system 160. Once the countermeasure controller 120 detects an errant vehicle, the countermeasure controller 120 may send an indication of the errant vehicle to the warning system. The indication of the errant vehicle may include a location of the errant vehicle as well.

The warning system 160 may communicate warnings directly or via a network, such as the warning system network 162. Part or all of the network 150 may be included in the warning network 162.

The warning system 160 may provide warnings to motorists, such as changing electronic warning sign 164 to indicate hazardous conditions. These warnings may include notifications about errant vehicles, including their locations, based on the indications provided by the countermeasure controller 120. FIG. 1 shows a warning of an errant vehicle “WARNING—ERRANT VEHICLE AT EXIT 666!”—displayed on an electronic warning sign 164. As shown in FIG. 1, the warning may include a location (Exit 666) of the errant vehicle.

The warning system 160 may instead, or in addition, provide warnings to motorists via direct or indirect electronic communications, such as updating web pages, sending e-mail, generating blog entries, and the like. FIG. 1 shows a warning 166 sent from the warning system 160 via the warning system network 162 to a vehicle in the prevailing flow of traffic 108. Other methods of informing motorists are possible as well.

The data network 150 and/or the warning network 162 may be local networks, such as a local area network (LAN), wireless LAN, public local network, private local network and/or secure local area network, and/or wide area networks (WANs), such as a wired WAN, a wireless WAN, a public WAN (e.g., the Internet), a secure WAN, and/or a private WAN, or both local and wide area networks.

Note that while the errant vehicle 114 shown in FIG. 1 is an automobile, other types of errant vehicles are possible as well, such as trucks, military vehicles, buses, trolleys, trains, aircraft, snowmobiles, as well as other vehicles moving on the ground. Also, there may be applicable scenarios where countermeasures could be applied in a similar fashion to those described above to errant vehicles traveling via water, such as in or around harbors.

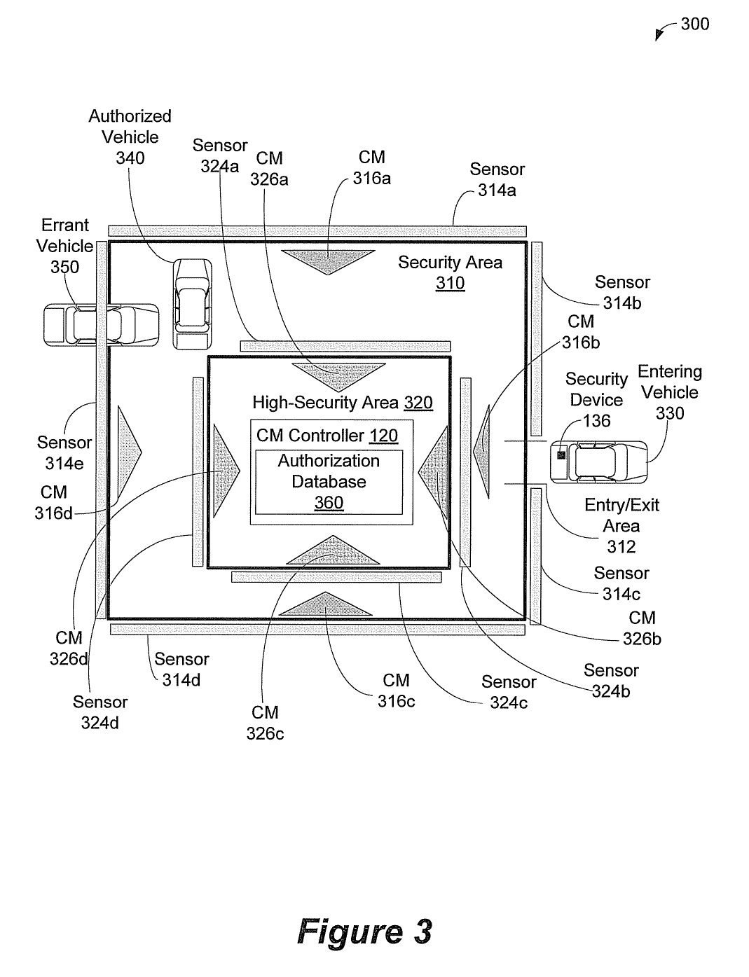

An authorized vehicle 118 may be permitted to travel along the errant vehicle path 116. The authorized vehicle 118 may have a security device 136 that communicates with the countermeasure controller 120 to override application of countermeasures against the authorized vehicle when traveling along errant vehicle path 116. The security device 116 may transmit an override request 119, perhaps on one or more specific frequencies, indicating that the authorized vehicle 118 is authorized to override countermeasures. The override request 119 may include authorization data. The authorization data may include passwords or other information used to verify to the countermeasure controller 120 that the override request is valid. In response to a valid override request, the countermeasure controller may permit the authorized vehicle 118 to travel along the errant vehicle path 116 (or other direction against exceeding the vector-difference threshold of the authorized-velocity vector) without applying countermeasures 132 and 134 against the authorized vehicle 118. The countermeasure controller may acknowledge the override request; that is, the countermeasure controller 120 may send an override response to an override request. The override response may indicate the validity of the override request. Authorization data is further discussed with respect to FIG. 3 below as well.

Also, the countermeasure controller 120 may track the override requests sent by the security device 136. The countermeasure controller 120 may keep track of the number of security devices detected, the number of override requests received, the time that override requests are received, the number of valid override requests, and/or the number of invalid override requests. Further, if the authorization data identifies a specific vehicle, the countermeasure controller 120 may track the time a specific vehicle has sent an override request, specific roadways used by the specific vehicle (e.g., off-ramp 104), and therefore, the time the specific vehicle used a specific roadway or roadways.

For example, suppose the off-ramp 104 was under repair and each repair vehicle used to rebuild the repair site of off-ramp 104 was equipped with a security device 136. Thus, the repair vehicles would be authorized to enter the repair site and other vehicles would be unauthorized. The countermeasure controller 120 may control access to the repair site of off-ramp 104 by applying countermeasures 132 and/or 134 to any unauthorized vehicle detected by sensors 122-126 attempting to enter the repair site. Further, the countermeasure controller 120 may track the time and number of repair vehicles at the repair site of off-ramp 104 as well, perhaps by tracking override requests of the repair vehicles. Tracking of the repair vehicles may indicate the time, number, and specific vehicles used to rebuild the repair site.

FIG. 1A shows an example scenario in which the countermeasure controller 120 could apply countermeasures as directed by a traffic manager 170, in accordance with embodiments of the invention.

FIG. 1A shows a highway 171 divided into three lanes 171a, 171b, and 171c. The traffic manager 170 is configured to control the reversible signs 172, 175, and 178 and thereby control flow of traffic in each respective lane 171a, 171b, and 171c independently. The traffic manager 170 may send a request or otherwise indicate to a reversible sign to display images, text, and/or symbols that inform drivers of vehicles on the highway 171 the authorized traffic flow in lanes 171a, 171b, 171c. For example, the reversible sign 172 displays an “X” to indicate traffic flow is not allowed in the “bottom-to-top” direction (that is the direction from the bottom of FIG. 1A to the top of FIG. 1A) in lane 171a, reversible sign 175 displays a “ [symbol] ” to indicate traffic flow is allowed in either the bottom-to-top direction or the opposite “top-to-bottom” direction in lane 171b, and the reversible sign 178 displays a “↑” to indicated traffic flow is allowed in the bottom-to-top direction. Correspondingly, FIG. 1A shows the prevailing flow of traffic 182 for the lane 171a is in the top-to-bottom direction, the prevailing flow of traffic 188 for the lane 171c is in the bottom-to-top direction, and the prevailing flow of traffic 185 for the lane 171b is in either the top-to-bottom or bottom-to-top direction.

FIG. 1A shows a countermeasure controller 120. The countermeasure controller 120 is connected to each of the sensors 173a-d, 176a-d, 179a-d, and 193a-b as well as to each countermeasure 174a-b, 177a-b, 180a-b, and 194. The countermeasure controller 120 and the various sensors 173a-d, 176a-d, 179a-d, and 193a-b and countermeasures 174a-b, 177a-b, 180a-b, and 194 may be connected using the connection techniques described above with respect to the countermeasure controller, sensors, and countermeasures of FIG. 1. The connections to the sensors 173a-d, 176a-d, 179a-d, and 193a-b and the countermeasures 74a-b, 177a-b, 180a-b, and 194 are not shown in FIG. 1A to enhance the readability of the figure.

The countermeasure controller 120 may be configured to receive requests from the traffic manager 170. The requests from the traffic manager 170 may request changing an authorized-velocity vector, enabling countermeasures, and/or disabling countermeasures at one or more locations. For example, if the traffic manager 170 determines the traffic flow in lane 171a should be reversed (i.e., the prevailing flow of traffic 182 should change to the bottom-to-top direction), then the traffic manager 170 may request the countermeasure controller 120 change the authorized-velocity vector for lane 171a to the top-to-bottom direction. The traffic manager 170 also may change the reversible sign 172 to indicate the changed prevailing flow of traffic 182 as well.

In another example, suppose the traffic manager 170 determines the prevailing flow of traffic 192 along the on-ramp 190 should flow in both the “on the on ramp” and the “off the on ramp” directions in response to an extraordinary surge in traffic. Extraordinary surges in traffic may come in response to a natural disaster (e.g., hurricane evacuation) or traffic arriving to a venue for a sporting event, political rally, or a performance. Then, the traffic manager 170 may request the countermeasure controller 120 should disable the countermeasure 194 to permit traffic flow against the prevailing flow of traffic 192 during the extraordinary surge in traffic. The countermeasure controller 120 may disable the countermeasure 194 by disabling the comparison between the authorized-velocity vector and the vehicle-velocity vector determined from the sensors 193a and 193b, by changing the threshold for the difference between authorized-velocity vector and the vehicle-velocity vector to exceed any possible difference between these vectors, and/or to disable the functionality of sending signals from the countermeasure controller 120 to countermeasure 194.

During the extraordinary surge in traffic, the traffic manager 170 and/or the countermeasure controller 120 may request the warning system 150 inform drivers about the change in the prevailing flow of traffic 192. FIG. 1A shows that the electronic warning sign 164 displaying the notification that traffic exiting highway 171 may use BR 443 off-ramp (off-ramp 190) After the extraordinary surge in traffic has ended, the traffic manager 170 may request the countermeasure controller 120 enable the countermeasure 192. In other words, an errant vehicle 196 traveling along the errant vehicle path 198 may then be subject to countermeasure 194 while the countermeasure 194 is enabled, but the errant vehicle 196 will not be subject to the countermeasure 194 while disabled.

Further, countermeasures may be disabled if traffic is allowed to flow in multiple directions, such as traffic in lane 171b traveling in both the top-to-bottom and bottom-to-top directions along prevailing traffic flow 185. Alternatively, the countermeasure controller 120 may compare a vehicle-velocity vector to two or more authorized-velocity vectors if traffic is allowed to flow in multiple directions, where each authorized-velocity vector corresponds to an authorized direction in the prevailing flow of traffic. For example, for lane 171b, the countermeasure controller 120 may compare a vehicle-velocity vector to both an authorized-velocity vector representing the top-to-bottom direction and an authorized-velocity vector representing the bottom-to-top direction before applying countermeasures only if both differences between the vehicle-velocity vector and authorized-velocity vectors exceed a threshold.

FIG. 2 shows an example scenario 200 in which an electronic countermeasure (ECM) device 250 could apply countermeasures to an errant vehicle 214, in accordance with embodiments of the invention.

The scenario shown in FIG. 2 is of a highway 201 with traffic flowing along prevailing flows of traffic (PFT) 202 and 202a, connected to road 210 via an off-ramp 204. The off-ramp 204 is marked by an exit sign 206. Vehicles on the road 210 are warned from entering off-ramp 204 by use of a warning sign 212.

A law-enforcement vehicle 220 is parked along the shoulder 208 of the off-ramp 204. A vehicle 214 is determined to be an errant vehicle 214, perhaps by use of sensors as described above with respect to FIG. 1 or by observation by a law-enforcement officer stationed within the law-enforcement vehicle 220.

Upon determination the errant vehicle 214 is traveling along an errant vehicle path 216, an electronic countermeasure may be applied to the errant vehicle 214. FIG. 2 shows an electronic-countermeasure (ECM) device 250 sending a vehicle-countermeasure (VCM) command 252 to a vehicle-countermeasure device 260 located in the errant vehicle 214.

For example, the vehicle-countermeasure command 252 may request the errant vehicle 214 stop, slow, change a vehicle-control parameter, and/or change direction. Upon reception of the vehicle-countermeasure command, the vehicle-countermeasure device 260 may apply a countermeasure to the errant vehicle 214.

An example countermeasure is to change one or more vehicle-control parameters in the errant vehicle 214. The vehicle-control parameters may include, but are not limited to, a fuel-flow rate of an engine, acceleration, speed, and/or vehicular direction of the errant vehicle 216. Other vehicle-control parameters may change as well. The vehicle-countermeasure command 252 may include the vehicle-control parameters and/or instructions to the vehicle as to the countermeasures to be applied. For example, the vehicle-countermeasure command 252 may instruct the vehicle to stop, slow down, or change directions. Continuing the example, if the vehicle-countermeasure command 252 includes an instruction to slow down or to change a vehicle-control parameter, the vehicle-countermeasure command 252 may include value(s) of the vehicle-control parameter(s), such as a fuel-flow rate or a speed, to indicate how much the errant vehicle 216 is to slow down or the changed vehicle-control parameter setting. Also, the vehicle-countermeasure command may include the name or other indication of the specific vehicle-control parameter as well (e.g, a command that indicates “Adjust vehicle-control parameters” with name of a vehicle-control parameter “MPH” and a value of “20” as well as another name of a vehicle-control parameter “Direction” and a value of “Left 90 degrees”.)

The vehicle-countermeasure device 260 may be integrated into an engine of the errant vehicle 214. In particular, the vehicle-countermeasure device 260 may be connected to one or more electronic-control units (ECUs), of the errant vehicle 214, perhaps via an engine control bus, to send requests to the ECUs. Example ECUs are engine-control units, electronic brake controllers, and electronic drive controllers. Other ECUs are possible as well.

The requests to the ECUs may include requests to change vehicle-control parameter(s), such as to slow or stop fuel-flow to the engine. In response to receiving the requests to change vehicle-control parameter(s), the ECU or ECUs may alter vehicle-control parameter(s) of the engine of the errant vehicle 214 and/or send one or more vehicle-control responses.

The use of commands to control ECUs within a mechanical system is also described in U.S. patent application Ser. No. 12/022,859, filed on Jan. 30, 2008, entitled “Apparatus, System, and Method for Onboard Degraded and Deadlined Mechanical System Alerting” by George L. Wright and Mark A. Wright, with attorney docket number H0017189-5548, and is incorporated by reference herein for all purposes.

The vehicle-countermeasure device 260 may interpret the one or more vehicle-control responses from the ECUs and may send information about the responses to the electronic-countermeasure device 250 (i.e., acknowledgements that countermeasures had been taken and/or information about applied countermeasures). The vehicle-countermeasure device 260 instead or in addition may provide information about the one or more vehicle-control responses to the driver and any other occupants of the errant vehicle 214, such as providing a visual and/or audible indication that the fuel-flow to the engine has been reduced (or stopped).

The technique of sending requests to devices within the vehicle to slow, stop, and/or change directions of the vehicle may be applied to devices other than ECUs as well. For example, one technique to slow, stop, or change the direction of the errant vehicle 114 is to send requests to one or more devices, such as brake controllers, to partially or completely engage one or more brakes of the errant vehicle 114. Changing the direction of the errant vehicle 214 may be performed by sending one or more requests to “drive-by-wire” device(s), such as an electronic stability control device, within the errant vehicle. Similarly, response(s) from these non-ECU devices may be interpreted by the vehicle-countermeasure device 260, and information provided to the electronic-countermeasure device 250 and/or the driver and other occupants of the errant vehicle 214.

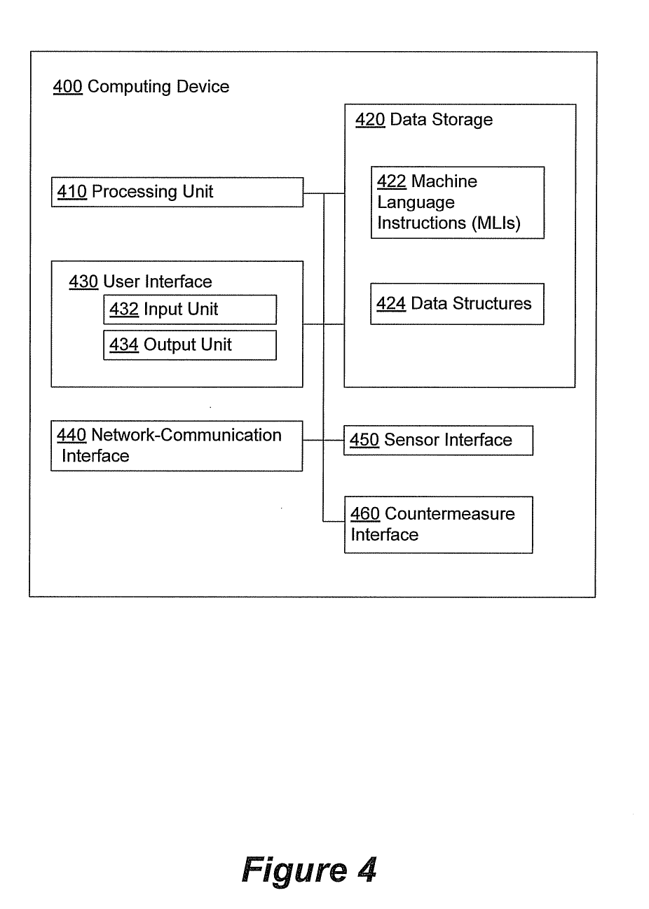

Instead of, or in addition to, changing vehicle-control parameters, the vehicle-countermeasure device 260 may apply a countermeasure by informing the driver of the errant vehicle 214 that the vehicle is traveling along the errant vehicle path 216. The vehicle-countermeasure device 260 may inform the driver by audibly and/or visually informing the driver of the errant vehicle 214 using an output unit, which is described in more detail with respect to FIG. 4 below. In response, the driver of the errant vehicle 214 may stop, slow, and/or change direction of the errant vehicle 214.

The vehicle-countermeasure command 252 may include a vehicle-countermeasure code. The vehicle-countermeasure code may be based on information about the errant vehicle 214, such as a license plate number, a vehicle identification number (VIN), a registration number, a description of the errant vehicle 214 and/or the occupants of the errant vehicle, or by other information about the errant vehicle. The information about the errant vehicle 214 may be textual, graphical (e.g., an image of a license plate of the errant vehicle 214), and or auditory (e.g., a report from the law-enforcement officer reciting the make/model and/or license plate number of the errant vehicle 214).

The information about the errant vehicle 214 may be sent in a vehicle-countermeasure query to a countermeasure-database 240. The electronic-countermeasure device 250 and/or another suitable device (e.g., a portable computing device) in the law-enforcement vehicle 220 may send the vehicle-countermeasure query to a countermeasure database 240, perhaps via a network such as network 230 shown in FIG. 2.

The countermeasure database 240 may include information about a plurality of vehicles, stored in a database, such as a relational database, or similar data structure suitable to retrieve information based on the information provided in the vehicle-countermeasure query. For each vehicle in the plurality of vehicles, the countermeasure database may store the vehicle information as well as the vehicle-countermeasure code associated with the vehicle. Upon reception of the vehicle-countermeasure query, the countermeasure database 240 may search for the information about the errant vehicle 214.

After searching for the information about the errant vehicle 214, the countermeasure database 240 may formulate and send a countermeasure-query response to the law-enforcement vehicle 220 and/or the electronic-countermeasure device 250. The countermeasure-query response may include a vehicle-countermeasure code. The vehicle-countermeasure code may be specific to the errant vehicle 214. For example, the vehicle-countermeasure code may be an authorization key that permits remote control of the errant vehicle. The manufacturer of the errant vehicle 214 and/or the vehicle-countermeasure device 260 or some other trusted authority may determine the authorization key. Also, a “master” authorization key may be determined as well that is treated as valid by a large number (or even all) vehicle-countermeasure devices 260. The master authorization key could be used in time-critical situations or provided in a broadcasts signal in a situation where a large number of vehicles were to be disabled (e.g., criminal activity using several nearby vehicles or a riot).

The vehicle-countermeasure device 260 may be configured to apply countermeasures in response to a vehicle-countermeasure command 252 only if the vehicle-countermeasure command 252 is valid. A vehicle-countermeasure command may be determined to be valid if it includes a valid authorization key. The valid authorization key may be sent as the vehicle-countermeasure code. The vehicle-countermeasure code may be checked for validity by comparing the vehicle-countermeasure code to a copy of the valid authorization key stored within the vehicle-countermeasure device 260. If the vehicle-countermeasure code is the same as the stored valid authorization key, then the vehicle-countermeasure code may be determined to be valid; otherwise, the vehicle-countermeasure code may be determined to be invalid. Many other methods of validating vehicle-countermeasure commands are possible as well. The use of validated vehicle-countermeasure commands provides security for the driver and occupants of the errant vehicle 214 by ensuring only valid electronic-countermeasures are applied to the errant vehicle 214.

Further, some or all of the communications between the law-enforcement vehicle 220, electronic countermeasure device 250, countermeasure database 240 and the vehicle-countermeasure device may be made secure (e.g., be encoded or encrypted) to prevent third party interception of vehicle information, countermeasure queries/response, and/or the vehicle-countermeasure command 252. In the case where communications are secured, the receiving device(s) may take measures to remove the security (e.g. decode or decrypt the vehicle-countermeasure command). Data may be secured and then security removed using cryptographic protocols and/or algorithms, such as, but not limited to, DES, AES, RSA, Diffie-Hellman, and/or DSA. Other cryptographic protocols and/or algorithms may be used as well or in addition to those listed herein to secure (and then decrypt/decode) communications.

If the information about the errant vehicle 214 is not found in the countermeasure database 240, the countermeasure-query response may include an indication that the vehicle information was not found, such as an error message, and/or provide an invalid vehicle-countermeasure code as part of the countermeasure-query response. In some circumstances, the countermeasure database 240 may be configured to provide a valid vehicle-countermeasure code only if prior legal authorization has been granted (e.g., a court order or arrest warrant) to use electronic countermeasures for a specific vehicle, a group of vehicles, and/or for any vehicle in a given jurisdiction or jurisdiction(s). Similarly, the countermeasure database 240 may be configured to provide an invalid vehicle-countermeasure code based on a legal restraint (e.g., a restraining order).

Also, the use of electronic countermeasures, including requests for vehicle-countermeasure codes, may be tracked, perhaps as data within the countermeasure database 240, to determine which vehicles have been determined to be errant vehicles, which vehicles were subject to electronic countermeasures, when vehicle-countermeasures codes were provided, and the like. This tracking data may be useful as evidence in any legal proceedings against the driver of the errant vehicle 214.

The use of an invalid vehicle-countermeasure code may prevent application of electronic countermeasures, if the vehicle-countermeasure device 260 only applies countermeasures in response to valid vehicle-countermeasure codes. However, the vehicle-countermeasure device 260 may provide informative countermeasures upon reception of a vehicle-countermeasure command (e.g., providing an audible and/or visual notification such as “This vehicle may be traveling in an errant direction”), regardless of the validity of the vehicle-countermeasure code.

Also, the electronic-countermeasure device 250 may be equipped to send another command that removes the electronic countermeasure. The command that removes the electronic countermeasure may be a vehicle-countermeasure command 252 with a separate command code. For example command codes, the “deactivate” command code may be used to remove electronic countermeasures, as well as command codes for application of countermeasures such as “slow vehicle”, “change vehicle control parameter”, “change vehicle direction” and/or “stop vehicle”. Many other command codes and command code formats are possible as well.

Also, a separate “deactivation” device from electronic-countermeasure device 250 may be used to deactivate electronic countermeasures. The deactivation device 272 may be used to permit movement of the errant vehicle 214 after the threat to other drivers has passed. FIG. 3 shows a tow truck 270 equipped with a deactivation device 272 configured to deactivate the electronic countermeasures and permit movement of the errant vehicle 214. The deactivation device 272 may also be configured to determine, such as by querying the countermeasure database 240, that electronic countermeasures have been applied to the errant vehicle 214 and/or that the electronic countermeasures may be deactivated. Once the deactivation device 272 determines that the electronic countermeasures may be deactivated, the driver of the tow truck 270 may use the deactivation device 272 to deactivate the electronic countermeasures.

Note that the terms “law-enforcement vehicle” and “law-enforcement officer” are used with respect to FIG. 2 as mere examples of authorized vehicles and personnel, respectively, that may utilize the electronic-countermeasure device 250. Other personnel, such as, but not limited to, military police, traffic wardens, security guards, and similar persons may utilize the electronic-countermeasure device 250. Similarly, “tow truck” and “driver of the tow-truck” are used with respect to FIG. 2 as mere examples of authorized vehicles and personnel, respectively, that may utilize the deactivation device 272. Other personnel, such as, but not limited to, law-enforcement personnel, military police, traffic wardens, security guards, emergency response personnel, and similar persons may utilize the deactivation device 272.

An Example Security Area Scenario

FIG. 3 shows an example scenario 300 in which countermeasures could be applied to vehicles 330, 340, and 350 entering security areas 310 and 320, in accordance with embodiments of the invention.

The scenario shown in FIG. 3 includes an entering vehicle 330 attempting to enter the security area 310 at an entry/exit area 312. The boundaries of each security area 310 and 320 covered by sensors 314a-314e and 324a-324d, respectively, and are shown delineated with thick lines on FIG. 3. An authorized vehicle 340 has already entered the security area 310 and an errant vehicle 350 is attempting to enter the security area 310 as well. FIG. 3 also shows a high-security area 320 as well.

FIG. 3 shows a countermeasure controller 120. The countermeasure controller 120 is connected to each of the sensors 314a-314e and 324a-324d as well as to each countermeasure 316a-316d and 326a-326d. The connections between the countermeasure controller 120 and the various sensors 314a-314e and 324a-324d and countermeasures 316a-316d and 326a-326d may be made using the connection techniques described above with respect to the countermeasure controller, sensors, and countermeasures of FIG. 1. The connections to the sensors 314a-314e and 324a-324d and the countermeasures 316a-316d and 326a-326d are not shown in FIG. 3 to enhance the readability of the figure.

While the countermeasure controller 120 is shown within high-security area 320, it is to be understood that the countermeasure controller 120 may be located remotely from the security areas 310 and 320 and in that circumstance, the countermeasure controller 120 may communicate with the sensors 314a-314e and 324a-324d and/or countermeasures 316a-316d and 326a-326d via a network such as described above with respect to FIG. 1 (not shown).

Each of the sensors 314a-314e covers a portion of the boundary of the security area 310 and may utilize the technologies described above with respect to sensors 122-126 of FIG. 1 to detect a position and/or a velocity of a vehicle. In particular, each of the sensors 314a-314e may detect that a vehicle is attempting to cross a portion of the boundary of the security area 310. Similarly, each of the sensors 324a-324d may detect that a vehicle is attempting to across a portion of the boundary of the high-security area 320.

A vehicle may attempt to enter a security area via specifically authorized entry and exit points. FIG. 3 shows an entering vehicle 330 attempting to enter the security area 310 at an entry/exit area 312. Sensor data from sensors 314b and/or 314c may indicate to the countermeasure controller 120 that the entering vehicle 330 is attempting to cross the boundary of the security area 310 at the entry/exit area 312.

Upon receiving the sensor data, the countermeasure controller 120 may send an authorization-data request for authorization data to the entering vehicle 330. The countermeasure controller 120 may send the authorization-data request via a network-communication interface. The authorization-data request may include a challenge, or request for specific authorization data, such as a password, security level, security clearance, digital signature, key information, and/or other data suitable for determining that the entering vehicle 330 is authorized to enter the security area 310.

In response, the entering vehicle 330 may send an authorization-data response. In particular, the security device 136 of the entering vehicle 330 may include the requested authorization data in the authorized-data response.

Then, the countermeasure controller 120 may receive the authorization-data response from the entering vehicle 330. The countermeasure controller 120 may examine the authorization data in the authorization-data response to determine that the entering vehicle 330 is authorized. For example, the countermeasure controller 120 may query an authorization database 360 using a query based on the authorization data. In response, the authorization database 360 may search data records (e.g., data-table rows or tuples in a relational database) that each contain one or more authorization indications for a vehicle. The authorization database 360 may compare the authorization data to the authorization indications in the data records. If a data record is found with an authorization indication in the authorization database 360 matching the received authorization data and/or a data record is found indicating the vehicle is authorized to enter security area 310, the authorization database 360 may send a query response to the countermeasure controller 120 indicating the entering vehicle 330 is attempting an authorized entry into the security area 310.

On the other hand, if no data record is found in the authorization database or a data record is found, but does not indicate the entering vehicle is authorized to enter the security area 310, the query response may indicate the entering vehicle 330 is not authorized and thus the entering vehicle 330 is attempting an unauthorized entry into the security area 310.

Note that while FIG. 3 shows the authorization database 360 as part of the countermeasure controller 120, the authorization database 360 may be on a separate computing device than the countermeasure controller 120 and, thus, the authorization database 360 and countermeasure controller 120 may be connected, either directly or via a network.

Also, the countermeasure controller 120 may wait for a specific amount of time after sending the authorization-data request (e.g., 30 or 60 seconds) to receive the authorization-data response from the entering vehicle 330. If no authorization-data response is received with the specific amount of time, the countermeasure controller may assume the entering vehicle 330 is attempting an unauthorized entry into the security area 310.

FIG. 3 shows that the errant vehicle 350 is attempting to cross the boundary of the security area 310. The sensor 314e may detect the attempt of the errant vehicle 350 and provide sensor data to the countermeasure controller about the attempt. The sensor data may include a time and/or an approximate location where the boundary of the security area 310 is being crossed. The countermeasure controller 120 may determine the attempted entry of the errant vehicle 330 into the security area 310 is unauthorized based on the location where the boundary of the security area 310 is being crossed.

Once the countermeasure controller 120 determines a vehicle is attempting an unauthorized entry to the security area 310 and/or security area 320, the countermeasure controller 120 may apply countermeasures 316a-d and/or 326a-d to the vehicle attempting unauthorized entry. The countermeasures 316a-d and/or 326a-d may utilize the countermeasure technologies and techniques (e.g., physical countermeasures, electronic countermeasures, and/or informational countermeasures) described above with respect to FIGS. 1 and 2.

Authorization into security area 310 may or may not permit entry in to high-security area 320, depending on the configuration of the countermeasure controller 120. The countermeasure controller 120 may be configured to permit entry into multiple security areas (e.g., security area 310 and 320) for all authorized vehicles, for some authorized vehicles (i.e., based on the authorization data, such as a security level or passphrase, sent from the entering vehicle 330 upon entry into the security area 310, the entering vehicle may be permitted to enter high-security area 320 as well), or to require all vehicles to present separate authorization data for each entry into and/or exit from a security area.

The countermeasure controller 120 may transmit the authorization-data request on a specific frequency. As such, if the entering vehicle 330 likely will only respond to the authorization-data request if the entering vehicle 330 has a receiver, such as security device 136 tuned to the specific frequency. The transmission of authorization-data requests on a specific frequency or frequencies ensures only vehicles equipped with the security device 136 tuned to the specific frequency or frequencies for the authorized entry points of secured areas, such as the entry/exit area 312, of the security area 310.

Further, an authorization-data response (to the authorization-data request) may be sent by the security device 136 on the specific frequency to ensure only the specific frequency is used for authorization data for a specific security area. Thus, security area 310 may send and receive authorization-data requests on one frequency (or set of frequencies) and the security area 320 may send and receive security data authorization-data requests on a second frequency (or set of frequencies). The second frequency may or may not be the same as the first frequency. The use of separate frequencies for separate security areas allows for increased security for each security area.

Also, entry and exit of vehicles may be tracked, perhaps as data within the authorization database 360, to determine which vehicles are in (or out) of a specific security area, the amount of time a vehicle is in a security area, the authentication data used to enter the security area, and the like. This tracking data may be useful to determine progress on a project. For example, if the security area 310 represents a worksite, each authorized vehicle, such as dump trucks or road graders, may be tracked to show how much activity has taken place over a specific time based on the tracking data of vehicle entries and exits.

The physical location of the security areas may affect the security level of each security area. For example, FIG. 3 shows the high-security area 320 is within the security area 310. As such, due to the physical location of the high-security area 320, the security area 310 must be entered before entering the high-security area 320, and thus high-security area 320 is secured by the security measures for both the security area 310 and the security area 320.

An Example Computing Device

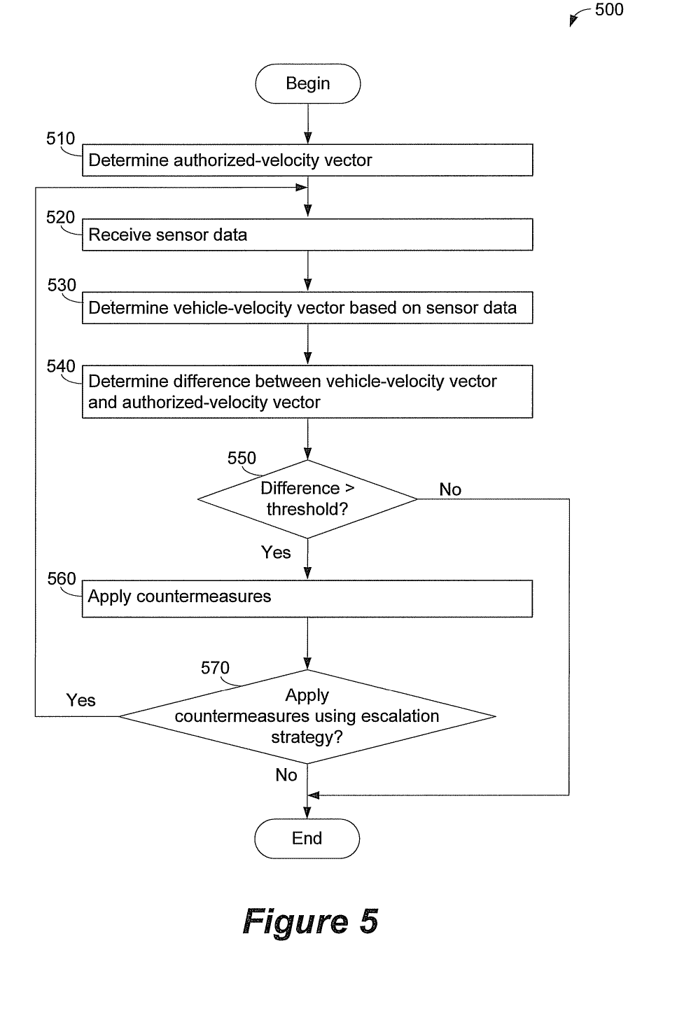

FIG. 4 is a block diagram of an example computing device 400, comprising a processing unit 410, data storage 420, a user interface 430, a network-communication interface 440, a sensor interface 450, and a countermeasure interface 460, in accordance with embodiments of the invention. A computing device 400 may be a desktop computer, laptop or notebook computer, personal data assistant (PDA), mobile phone, embedded processor, or any similar device that is equipped with a processing unit capable of executing machine-language instructions that implement at least part of the herein-described methods 500, 600 and/or 700, described in more detail below with respect to FIGS. 5, 6, and 7, respectively, and/or herein-described functionality of a countermeasure controller, a countermeasure device, a vehicle-countermeasure device, an authorization database, a security device, and/or a countermeasure database.

The processing unit 410 may include one or more central processing units, computer processors, mobile processors, digital signal processors (DSPs), microprocessors, computer chips, and similar processing units now known and later developed and may execute machine-language instructions and process data.

The data storage 420 may comprise one or more storage devices. The data storage 420 may include read-only memory (ROM), random access memory (RAM), removable-disk-drive memory, hard-disk memory, magnetic-tape memory, flash memory, and similar storage devices now known and later developed. The data storage 420 comprises at least enough storage capacity to contain machine-language instructions 422 and data structures 424.

The machine-language instructions 422 and the data structures 424 contained in the data storage 420 include instructions executable by the processing unit 410 and any storage required, respectively, to perform some or all of the herein-described functions of a countermeasure controller, a countermeasure device, a vehicle countermeasure device, and/or a countermeasure database, and/or to perform some or all of the procedures described in methods 500, 600 and/or method 700.

The user interface 430 may comprise an input unit 432 and/or an output unit 434. The input unit 432 may receive user input from a user of the computing device 400. The input unit 432 may comprise a keyboard, a keypad, a touch screen, a computer mouse, a track ball, a joystick, and/or other similar devices, now known or later developed, capable of receiving user input from a user of the computing device 400.

The output unit 434 may provide output to a user of the computing device 400. The output unit 434 may comprise a visible output device for generating visual output(s), such as one or more cathode ray tubes (CRT), liquid crystal displays (LCD), light emitting diodes (LEDs), displays using digital light processing (DLP) technology, printers, light bulbs, and/or other similar devices, now known or later developed, capable of displaying graphical, textual, and/or numerical information to a user of computing device 400. The output unit 434 may alternately or additionally comprise one or more aural output devices for generating audible output(s), such as a speaker, speaker jack, audio output port, audio output device, earphones, and/or other similar devices, now known or later developed, capable of conveying sound and/or audible information to a user of computing device 400.

The network-communication interface 440 may be configured to send and receive data over a wired-communication interface and/or a wireless-communication interface. The wired-communication interface, if present, may comprise a wire, cable, fiber-optic link or similar physical connection to a data network, such as a wide area network (WAN), a local area network (LAN), one or more public data networks, such as the Internet, one or more private data networks, or any combination of such networks. The wireless-communication interface, if present, may utilize an air interface, such as a ZigBee, Wi-Fi, and/or WiMAX interface to a data network, such as a WAN, a LAN, one or more public data networks (e.g., the Internet), one or more private data networks, or any combination of public and private data networks. In some embodiments, the network-communication interface 440 is configured to send and/or receive data over multiple communication frequencies, as well as being able to select a communication frequency out of the multiple communication frequency for utilization.

The sensor interface 450 may permit communication with one or more sensors to permit the sensors to provide sensor data to the computing device 400 and/or to receive commands that permit sensor maintenance (e.g., setup commands, configuration parameter settings, and the like). The sensor interface 450 may include a wired-sensor interface and/or a wireless-sensor interface. The wired-sensor interface and the wireless-sensor interface may utilize the technologies described above with respect to the wired-communication interface of the network-communication interface 440 and the wireless-communication interface of the network-communication interface 440, respectively.

The countermeasure interface 460 may permit communication with one or more countermeasures. The countermeasure interface 460 may also, or instead, permit reception and/or transmission of vehicle-countermeasure command(s). The countermeasure interface 460 may include a wired-countermeasure interface and/or a wireless-countermeasure interface. The wired-countermeasure interface and the wireless-countermeasure interface may utilize the technologies described above with respect to the wired-communication interface of the network-communication interface 440 and the wireless-communication interface of the network-communication interface 440, respectively.

Example Methods for Applying Countermeasures to a Vehicle

FIG. 5 is a flowchart depicting an example method 500 for applying countermeasures to a vehicle, in accordance with an embodiment of the invention. It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Method 500 begins at block 510. At block 510, an authorized-velocity vector for a vehicle may be determined. The authorized-velocity vector may be specified by user input or other input data. The authorized-velocity vector may be determined on a per-roadway basis.

At block 520, sensor data may be received. The sensor data may be determined by one or more sensors. The sensor data may indicate a location and/or a velocity of the vehicle. The sensor data may be received by a countermeasure controller.

At block 530, a vehicle-velocity vector may be determined. The countermeasure controller may determine the vehicle-velocity vector based on the sensor data. For example, suppose the sensor data from a first sensor indicates a first location L₁ of the vehicle at a first time T₁. Further suppose that the sensor data from a second sensor indicates a second location L₂ of the vehicle at a second time T₂. Then, the direction of the vehicle-velocity vector may be determined by taking the vector difference L₂−L₁ and the magnitude (e.g., speed) S of the vehicle-velocity vector may be determined, for example, by the equation:

$$S = \frac{{L}_{2} - {L}_{1}}{{T}_{2} - {T}_{1}} .$$

At block 540, a difference between the vehicle-velocity vector and the authorized-velocity vector may be determined.

At block 550, the difference may be compared to a threshold. If the difference exceeds the threshold, the method 500 may proceed to block 560. If the difference is less than the threshold, the method 500 may end.

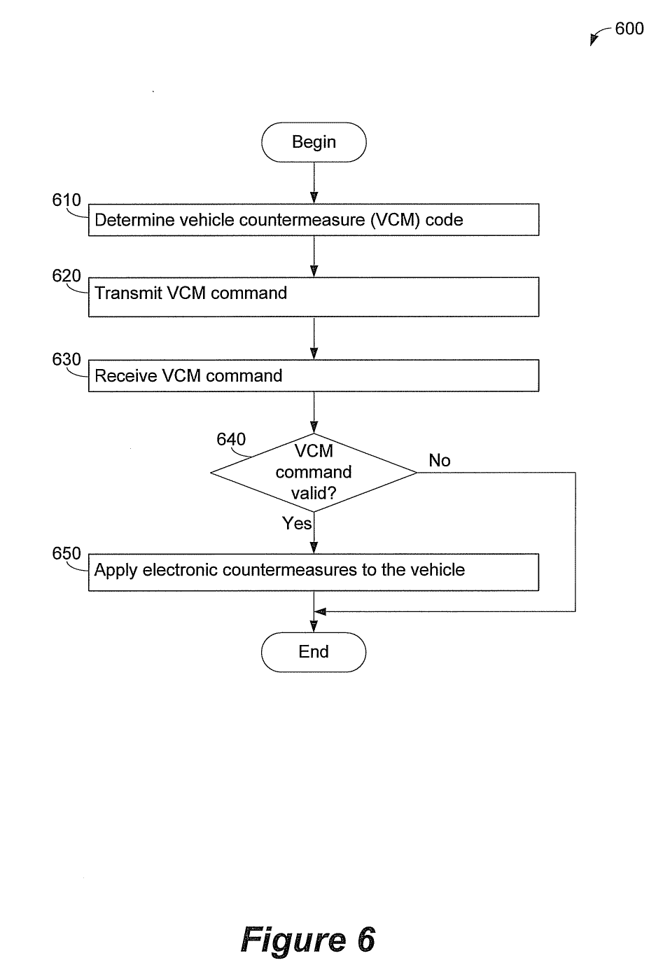

At block 560, countermeasures may be applied to the vehicle. The vehicle may be determined to be an errant vehicle, as the difference has exceeded the threshold. The countermeasures may be applied to the errant vehicle, including but not limited to informational countermeasures, physical countermeasures, electromagnetic countermeasures and/or electronic countermeasures. The electronic countermeasures may be applied using the techniques of method 600, described with respect to FIG. 6 below.

At block 570, a determination may be made that the countermeasures are to be applied to the errant vehicle using an escalation strategy. For example, a first countermeasure, such as an informational countermeasure, may first be applied to the errant vehicle and then a second countermeasure, such as a physical countermeasure, may then be applied. The escalation strategy may permit the errant vehicle to change the vehicle-velocity vector (i.e., permit the errant vehicle to slow, stop, or change direction) before applying further countermeasures. As such, the countermeasure controller may receive additional sensor data and determine an updated vehicle-velocity vector before applying additional countermeasures. Thus, if an escalation strategy is applied, the method 500 may proceed to block 520. If an escalation strategy is not applied, the method 500 may end.

An Example Method for Applying Electronic Countermeasures to a Vehicle.

FIG. 6 is a flowchart depicting an example method 600 for applying electronic countermeasures to a vehicle, in accordance with an embodiment of the invention.

Method 600 begins at block 610, where a vehicle-countermeasure code is determined. The vehicle-countermeasure code may based on vehicle information about a vehicle. The vehicle information may include a license plate number, a VIN, a registration number, and/or a description of the vehicle. The vehicle-countermeasure code may be determined by sending a query to a countermeasure database storing information about a plurality of vehicles and related vehicle-countermeasure codes. The countermeasure database may search the database for the vehicle information. Responsive to finding the vehicle information, the countermeasure database may return a valid vehicle-countermeasure code and, responsive to not finding the vehicle information, the countermeasure database may return an indication that the vehicle information is not found and/or an invalid vehicle-countermeasure code.

At block 620, a vehicle-countermeasure command is transmitted. The vehicle-countermeasure command may include the vehicle-countermeasure code. A countermeasure controller may transmit the vehicle-countermeasure command. The vehicle-countermeasure command may be secured, such as by being encrypted using cryptographic protocols and/or algorithms described above with respect to FIG. 2, before transmission.

At block 630, the vehicle-countermeasure command is received. A vehicle-countermeasure device in the vehicle may receive the vehicle-countermeasure command. If the vehicle-countermeasure command is secured, the receiving device (e.g., the vehicle-countermeasure device) may take measures to decode or decrypt the vehicle-countermeasures upon reception.

At block 640, a determination is made whether the vehicle-countermeasure command is valid. The validity determination may be made based on data within the vehicle-countermeasure command, such as the vehicle-countermeasure code. The received vehicle-countermeasure code may be compared to a valid authorization key. If the received vehicle-countermeasure code matches the valid authorization key, the vehicle-countermeasure command may be determined to be valid; otherwise, the vehicle-countermeasure command may be determined to be invalid. If the vehicle-countermeasure command is valid, the method 600 may proceed to block 650. If the vehicle-countermeasure command is invalid, the method 600 may end.

At block 650, electronic countermeasures may be applied to the vehicle. The electronic countermeasures may be applied to the vehicle by the vehicle-countermeasure device. The applied countermeasures may be based on the vehicle-countermeasure command. The vehicle-countermeasure command may include an instruction to the vehicle, such as to stop, slow down, change direction, or to change one or more vehicle-control parameters. The vehicle-countermeasure command may include specific value(s) of the vehicle-control parameter(s) to be applied by the vehicle. The vehicle-countermeasure device may apply informational countermeasures upon reception of the vehicle-countermeasure command as well, such as visually and/or audibly requesting the driver of the vehicle to slow down, stop, or change direction.

After completing the procedures of block 650, method 600 may end.

An Example Method for Determining Authorized Entry into a Secured Area

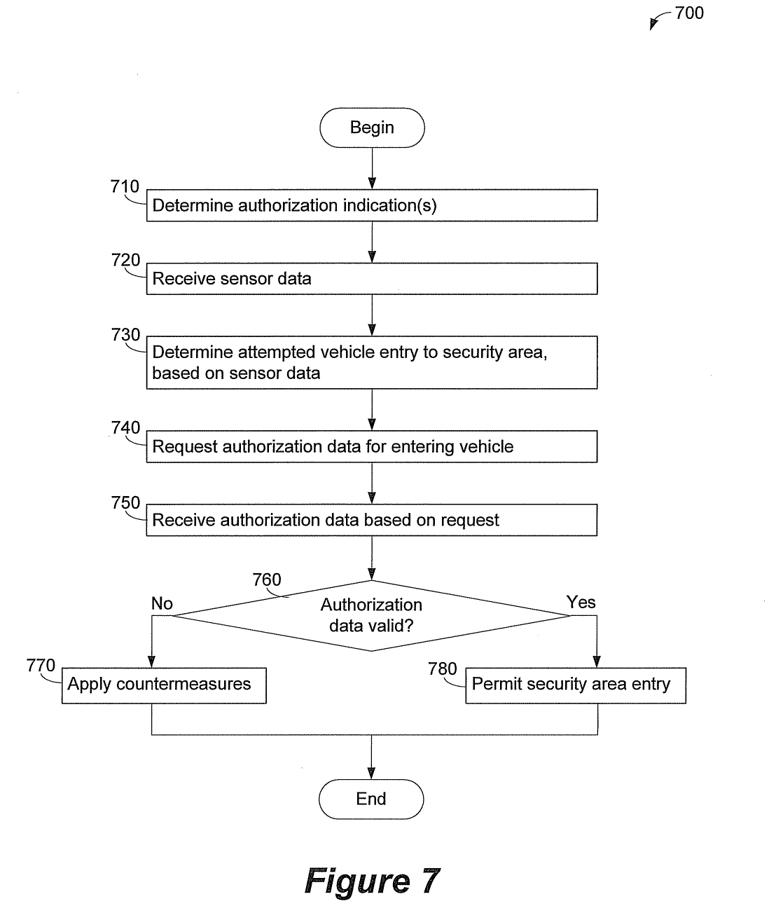

FIG. 7 is a flowchart depicting an example method for determining authorized entry into a secured area, in accordance with an embodiment of the invention.

Method 700 begins at block 710.

At block 710, authorization indications are determined. The authorization indications may be stored in data records in an authorization database. The data records may include, instead or as well, an indication that a vehicle is authorized to enter one or more security areas.

At block 720, sensor data is received. The sensor data may be sent from a sensor to a countermeasure controller. The sensor data may indicate a location of a vehicle.

At block 730, a determination is made that a vehicle is attempting entry into a security area. The determination about the entering vehicle may be made by a countermeasure controller. The countermeasure controller may make the determination based on the sensor data, such as the indicated location of a vehicle. Based on the indicated location of the entering vehicle and the known location(s) of security area(s), the countermeasure controller may determine the entering vehicle is attempting to enter into a security area.

At block 740, a request for authorization data for the entering vehicle is made. The authorization-data request may be made by the countermeasure controller. The authorization-data request may be secured, such as by use of the encryption techniques described above with respect to FIG. 2 and/or block 620 of FIG. 6. The authorization-data request may include a challenge or request for specific authorization data. The authorization-data request may be sent to a device in the vehicle requesting entry, such as a security device.

At block 750, the authorization data for the entering vehicle is received. The authorization data may be received by the countermeasure controller in an authorization-data response from the entering vehicle, perhaps from the security device in the entering vehicle. The countermeasure controller may, in some circumstances, make a determination that the authorization data is invalid without receiving authorization data. For example, the countermeasure controller may determine the authorization data is invalid if a specific amount of time elapses after sending the authorization-data request without reception of an authorization-data response. As a second example, the countermeasure controller may determine the authorization data is invalid if the entering vehicle attempts to enter the security area at a non-authorized entry/exit point.

At block 760, a determination is made whether the authorization data for the entering vehicle is valid. If the authorization data is determined to be invalid, the method 700 may proceed to block 770. If the authorization data is determined to be valid, the method 700 may proceed to block 780.

At block 770. countermeasures may be applied to the vehicle, as the entering vehicle did not provide valid authorization data to enter into the security area. The countermeasures may be applied to the entering vehicle, including but not limited to informational countermeasures, physical countermeasures, electromagnetic countermeasures and/or electronic countermeasures. The electronic countermeasures may be applied using the techniques of method 600, described with respect to FIG. 6 above. The countermeasures may be applied to the entering vehicle using an escalation strategy, such as described above with respect to FIGS. 1 and 5. After performing the procedures of block 770, the method 700 may end.

At block 780, the entering vehicle may be permitted entry into the security area. After performing the procedures of block 780, the method 700 may end.

### CONCLUSION

Exemplary embodiments of the present invention have been described above. Those skilled in the art will understand, however, that changes and modifications may be made to the embodiments described without departing from the true scope and spirit of the present invention, which is defined by the claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

What is claimed is:

1. A method, comprising:
determining a vehicle-velocity vector of a vehicle, based on sensor data received from one or more sensors, wherein the vehicle-velocity vector comprises a magnitude component and a direction component;
determining a difference between the vehicle-velocity vector and an authorized-velocity vector, wherein the difference is based on the magnitude component and the direction component of the vehicle-velocity vector;
comparing the difference to a threshold; and
responsive to determining that the vehicle-velocity vector exceeds the threshold, applying a countermeasure to the vehicle.

2. The method of claim 1, wherein the velocity vector is determined based on sensor data from a first sensor and a second sensor, and wherein data is taken from the second sensor after taking data from the first sensor.

3. The method of claim 1, wherein applying the countermeasure comprises applying the countermeasure using an escalation strategy.

4. The method of claim 1, wherein the escalation strategy comprises applying a first countermeasure and a second countermeasure.

5. The method of claim 1, wherein the countermeasure comprises a physical countermeasure.

6. The method of claim 5, wherein the physical countermeasure comprises a barrier.

7. The method of claim 1, wherein the countermeasure comprises an electronic countermeasure applied to the vehicle that stops the vehicle.

8. The method of claim 1, wherein the countermeasure comprises engaging a warning device.

9. The method of claim 8, wherein the warning device comprises an electronic warning sign.

10. The method of claim 1, further comprising:
receiving a request to change the authorized-velocity vector; and
responsive to the request, changing the authorized-velocity vector.

11. The method of claim 1, further comprising:
receiving a request to disable the countermeasure; and
responsive to the request, disabling the countermeasure.

12. A countermeasure controller, comprising:
a processor;
data storage;
a sensor interface; and
machine language instructions stored in the data storage and executable by the processor to perform functions including:
determining that an entering vehicle is attempting to enter a security area based on sensor data received via the sensor interface,
requesting authorization data for the entering vehicle,
receiving the requested authorization data,
determining whether a vehicle is authorized based on the authorization data, and
responsive to determining that the vehicle is not authorized, applying a countermeasure to the vehicle.

13. The countermeasure controller of claim 12, wherein determining whether the vehicle is authorized comprises determining whether a vehicle is authorized based on a query to an authorization database, wherein the query comprises the authorization data.

14. The countermeasure controller of claim 13, further comprising a network-communication interface, wherein determining whether a vehicle is authorized comprises:
connecting to the database using the network interface; and
sending the query to the database;
receiving a query result from the database; and
determining whether the vehicle is authorized, based on the query result.

15. The countermeasure controller of claim 14, wherein the network-communication interface is configured to send and receive information on a plurality of frequencies, and wherein determining whether the vehicle is authorized comprises:
sending a first challenge to the vehicle via the network-communication interface on a first frequency;
receiving a first challenge result; and
determining whether the vehicle is authorized to enter a first area based on the first challenge result.

16. The countermeasure controller of claim 15, wherein determining the vehicle is authorized further comprises:
sending a second challenge to the vehicle via the network-communication interface on a second frequency;
receiving a second challenge result via the network-communication interface; and
determining whether the vehicle is authorized to enter a second area based on the second challenge result;

17. A vehicle-countermeasure device, comprising:
a processor;
data storage;
a network interface; and
machine language instructions stored in the data storage and executable by the processor to perform functions including:
receiving a vehicle-countermeasure command via the network interface,
determining whether the vehicle-countermeasure command is valid, and
responsive to determining that the vehicle-countermeasure command is valid, applying an electronic countermeasure to the vehicle.

18. The vehicle-countermeasure device of claim 17, wherein the vehicle-countermeasure command comprises a vehicle-countermeasure code, and wherein determining whether the vehicle-countermeasure command is valid comprises determining whether the vehicle-countermeasure code is valid.

19. The vehicle-countermeasure device of claim 17, wherein the functions further include:
responsive to determining that the vehicle-countermeasure command is invalid, applying an informative countermeasure to the vehicle.

20. The vehicle-countermeasure device of claim 17, wherein the vehicle-countermeasure command comprises a named vehicle-control parameter and a value of a vehicle-control parameter, and wherein machine language instructions for applying the electronic countermeasure comprise instructions for changing the named vehicle-control parameter to the value of the vehicle-control parameter.
